(19) United States
(12) Patent Application Publication
(10) Pub. No.: US 2026/0179847 A1
(43) Pub. Date: Jun. 25, 2026

(54) MULTILAYER CERAMIC CAPACITOR AND METHOD OF MANUFACTURING THE SAME

(71) Applicant: SAMSUNG ELECTRO-MECHANICS CO., LTD., Suwon-si (KR)

(72) Inventors: Bumsuk Kang, Suwon-si (KR); Daewoo Yoon, Suwon-si (KR); Da Mi Kim, Suwon-si (KR); Jaehoon Bang, Suwon-si (KR); Sujin Lee, Suwon-si (KR); Wansik Kim, Suwon-si (KR); Junghyun Kim, Suwon-si (KR); Jeong Ryeol Kim, Suwon-si (KR)

(73) Assignee: SAMSUNG ELECTRO-MECHANICS CO., LTD., Suwon-si (KR)

(21) Appl. No.: 19/245,070

(22) Filed: Jun. 20, 2025

(30) Foreign Application Priority Data
Dec. 20, 2024 (KR) 10-2024-0192998

(51) Int. Cl. H01G 4/232; C04B 35/64; H01G 4/008; H01G 4/012; H01G 4/30

(52) U.S. Cl. CPC H01G 4/2325; C04B 35/64; H01G 4/008; H01G 4/012; H01G 4/30

(57) ABSTRACT

A multilayer ceramic capacitor may include a capacitor body including a dielectric layer and an internal electrode, and an external electrode located on an outer side of the capacitor body, and including Ni and an auxiliary element which includes at least one of Sn, Al, Zn, In, and Co, where the internal electrode may include a first interface region in contact with the external electrode, and where the first interface region may include an alloy including Ni and the auxiliary element together.

### CROSS-REFERENCE TO RELATED APPLICATION

This application claims priority to and the benefit of Korean Patent Application No. 10-2024-0192998 filed with the Korean Intellectual Property Office on Dec. 20, 2024, the entire contents of which is incorporated herein by reference.

### BACKGROUND

The present disclosure relates to a multilayer ceramic capacitor and a method of manufacturing the same.

Electronic components using ceramic materials include capacitors, inductors, piezoelectric elements, varistors, or thermistors. Among ceramic electronic components, a multilayer ceramic capacitor (MLCC) may be used in various electronic devices due to advantages such as a small size, a high capacitance, an easy mounting feature, and the like.

For example, multilayer ceramic capacitor may be used in a condenser in the form of a chip that is mounted on a substrate of various electronic products, such as an image device such as liquid crystal display (LCD), plasma display device panel, an organic light emitting diode (OLED), a computer, a personal portable terminal and a smart phone, to charge and discharge electricity.

Recently, with the miniaturization of electronic products, multilayer ceramic capacitors are also required to be miniaturized and to have ultra-high capacitance. For this purpose, the thickness of the dielectric layer and internal electrode layer is reduced, and a multilayer ceramic capacitor having a structure in which a greater number of dielectric layers and internal electrode layers are stacked is being developed. These ultra-small and ultra-high-capacitance multilayer ceramic capacitors are recently used in fields that require a high level of reliability, such as electric vehicles, and accordingly, high stability and high reliability are required for such capacitors.

### SUMMARY

According to one aspect of the present disclosure, a multilayer ceramic capacitor with improved reliability and low-resistance characteristics may be provided.

According to another one aspect of the present disclosure, a method for manufacturing a multilayer ceramic capacitor with improved reliability and low-resistance characteristics may be provided.

However, the objective of the present disclosure is not limited to the aforementioned one, and may be extended in various ways within the spirit and scope of the present disclosure.

A multilayer ceramic capacitor may include a capacitor body including a dielectric layer and an internal electrode, and an external electrode located on an outer side of the capacitor body, and including Ni and an auxiliary element including at least one selected from the group consisting of Sn, Al, Zn, In, and Co, where the internal electrode may include a first interface region in contact with the external electrode, and where the first interface region may include an alloy including Ni and the auxiliary element together.

The first interface region may be a region in which a content of the auxiliary element measured through scanning electron microscopy-energy dispersive X-ray spectroscopy (SEM-EDS) along a direction from an interface between the internal electrode and the external electrode toward an interior of the internal electrode may be 5 mol % or more of a total amount of Ni and the auxiliary element.

The external electrode may include an electrode layer electrically connected to the internal electrode, and the electrode layer may include Ni and the auxiliary element.

The electrode layer may include a second interface region in contact with the internal electrode, and the second interface region may include an alloy of Ni and the auxiliary element.

The second interface region may be a region where a content of the auxiliary element measured through SEM-EDS along a direction from an interface between the electrode layer and the internal electrode toward an interior of the electrode layer is 5 mol % to 20 mol % of a total amount of Ni and the auxiliary element.

The first interface region and the second interface region may be connected.

The electrode layer may not include Cu.

A content of Ni may be 80 mol % to 95 mol % with respect to a total amount of Ni and the auxiliary element included in the external electrode.

A content of the auxiliary element may be 5 mol % to 20 mol % with respect to a total amount of Ni and the auxiliary element included in the external electrode.

Ni included in the external electrode may have a form of a Ni metal.

The internal electrode may include Ni, and the internal electrode and the external electrode may be electrically connected through the alloy.

The external electrode may further include glass.

A content of the glass may be 1 part by weight to 40 parts by weight based on totally 100 parts by weight of Ni and the auxiliary element included in the external electrode.

The external electrode may include a plurality of Ni metals and a plurality of auxiliary elements, and an average particle diameter of the Ni metal and an average particle diameter of the auxiliary element included in the external electrode are 0.05 μm to 10 μm, respectively.

A method of preparing a multilayer ceramic capacitor may include applying a paste for forming an electrode layer to a first surface of a capacitor body including a dielectric layer and an internal electrode, and forming the electrode layer of an external electrode by sintering the paste for forming an electrode layer, where the paste for forming an electrode layer may include Ni and an auxiliary element including at least one of Sn, Al, Zn, In, and Co, where the internal electrode may include a first interface region in contact with the external electrode, and where the first interface region may include an alloy of Ni and the auxiliary element.

The sintering may be performed at 500° C. to 850° C.

The electrode layer may include a second interface region in contact with the internal electrode, and the second interface region may include an alloy of Ni and the auxiliary element.

A content of Ni in the paste for forming an electrode layer may be 80 mol % to 95 mol % with respect to a total amount of Ni and the auxiliary element included in the paste for forming an electrode layer.

A content of the auxiliary element in the paste for forming an electrode layer may be 5 mol % to 20 mol % with respect to a total amount of Ni and the auxiliary element included in the paste for forming an electrode layer.

According to some example embodiments of the present disclosure, electrical connectivity between an external electrode and an internal electrode of a multilayer ceramic capacitor may be improved, and the capacitance characteristics and moisture resistance reliability may be improved.

According to some example embodiments of the present disclosure, cracks of a multilayer ceramic capacitor in a radial direction may be suppressed, and the structural stability and reliability may be improved.

### BRIEF DESCRIPTION OF THE DRAWINGS

FIG. 1 is a perspective view showing a multilayer ceramic capacitor according to an example.

FIG. 2 is a cross-sectional view of a multilayer ceramic capacitor taken along line I-I′ of FIG. 1.

FIG. 3 is a cross-sectional view of a multilayer ceramic capacitor taken along line II-II′ of FIG. 1.

FIG. 4 is an enlarged partial cross-sectional view of the portion A of FIG. 2.

FIG. 5 is a scanning electron microscopy (SEM) analysis image of the multilayer ceramic capacitor according to Example 7.

FIG. 6 is a SEM analysis image of the multilayer ceramic capacitor according to Comparative Example 7.

FIG. 7 is a graph showing the capacitance of the multilayer ceramic capacitor according to each of Example 7 and Comparative Example 7.

### DETAILED DESCRIPTION OF THE EMBODIMENTS

The present disclosure will be described more fully hereinafter with reference to the accompanying drawings, in which embodiments of the disclosure are shown. The drawings and description are to be regarded as illustrative in nature and not restrictive. Like reference numerals designate like elements throughout the specification. Further, some constituent elements in the drawings may be exaggerated, omitted, or schematically illustrated, and a size of each constituent element does not reflect the actual size entirely.

The accompanying drawings are provided only in order to allow embodiments disclosed in the present specification to be easily understood and are not to be interpreted as limiting the spirit disclosed in the present specification, and it is to be understood that the present disclosure includes all modifications, equivalents, and substitutions without departing from the scope and spirit of the present disclosure.

Terms including ordinal numbers such as first, second, and the like will be used only to describe various constituent elements, and are not to be interpreted as limiting these constituent elements. The terms are only used to differentiate one constituent element from other constituent elements.

It will be understood that when an element such as a layer, film, region, area, or substrate is referred to as being “on” or “above” another element, it can be directly on the other element or intervening elements may also be present. In contrast, when an element is referred to as being “directly on” another element, there are no intervening elements present. Further, in the specification, the word “on” or “above” means disposed on or below the object portion, and does not necessarily mean disposed on the upper side of the object portion based on a gravitational direction.

Throughout the specification, it should be understood that the term “include”, “comprise”, “have”, or “configure” indicates that a feature, a number, a step, an operation, a constituent element, a part, or a combination thereof described in the specification is present, but does not exclude a possibility of presence or addition of one or more other features, numbers, steps, operations, constituent elements, parts, or combinations, in advance. Unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Furthermore, throughout the specification, “connected” does not only mean when two or more elements are directly connected, but also when two or more elements are indirectly connected through other elements, and when they are physically connected or electrically connected, and further, it may be referred to by different names depending on a position or function, and may also be referred to as a case in which respective parts that are substantially integrated are linked to each other.

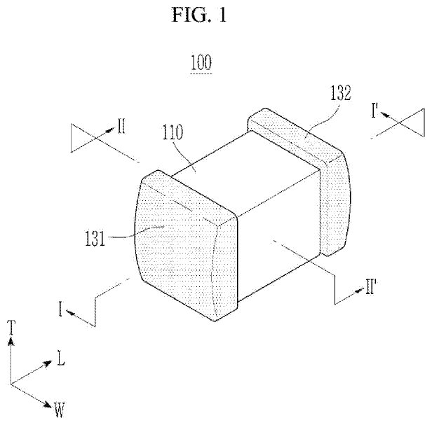

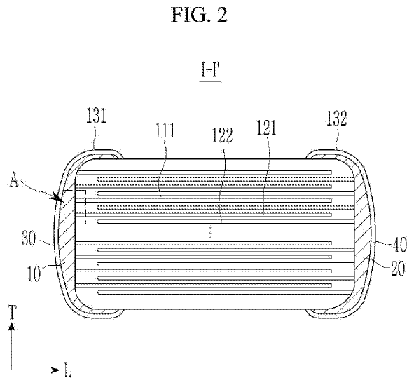

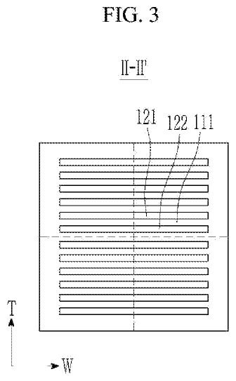

FIG. 1 is a perspective view conceptually showing a multilayer ceramic capacitor according to an example. FIG. 2 is a conceptual cross-sectional view of a multilayer ceramic capacitor taken along line I-I′ of FIG. 1. FIG. 3 is a conceptual cross-sectional view of a multilayer ceramic capacitor taken along line II-II′ of FIG. 1.

Referring to FIG. 1 to FIG. 3, a multilayer ceramic capacitor 100 may include a capacitor body 110 and external electrodes 131 and 132 disposed on an outer side of the capacitor body 110. The external electrodes 131 and 132 may include a first external electrode 131 and a second external electrode 132 disposed at both ends facing each other in a length direction (L-axis direction) of the capacitor body 110.

The L-axis, W-axis and T-axis shown in FIG. 1 to FIG. 3 represent a length direction, a width direction, and a stacking direction of the capacitor body 110, respectively. Here, the stacking direction (T-axis direction) may be a direction perpendicular to wide surfaces (major surfaces) of the sheet-shaped components, and as an example, may be used as the same concept as a direction in which a dielectric layer 111 is stacked. The length direction (L-axis direction) may be a direction generally perpendicular to the stacking direction (T-axis direction) in a direction extending parallel to wide surfaces (major surface) of the sheet-shaped components, and as an example, may be a direction in which the first external electrode 131 and the second external electrode 132 are located on both sides. The width direction (W-axis direction) may be a direction generally perpendicular to the stacking direction (T-axis direction) and the length direction (L-axis direction) in a direction extending parallel to wide surfaces (major surface) of the sheet-shaped components, and the lengths of the sheet-shaped components in the length direction (L-axis direction) may be greater than the lengths in the width direction (W-axis direction).

In an example, the capacitor body 110 may include a generally hexahedral shape.

Hereinafter, for convenience of description, in the capacitor body 110, both surfaces facing each other in the stacking direction (T-axis direction) may be a first surface and a second surface, both surfaces connected to the first surface and the second surface and facing each other in the length direction (L-axis direction) may be a third surface and a fourth surface, both surfaces connected to the first surface and the second surface, connected to the third surface and the fourth surface, and facing each other in the width direction (W-axis direction) may be a fifth surface and a sixth surface.

The first surface, which is a lower surface of the capacitor body 110, may be a surface facing a mounting direction of the multilayer ceramic capacitor 100. At least one of the first surface to the sixth surface may be flat. Alternatively, at least one of the first surface to the sixth surface may be a curved surface with a convex central portion, and an edge, which is a boundary of each surface may be rounded.

The shape and size of the capacitor body 110 and the number of stacks of the dielectric layer 111 are not limited to what is illustrated in the drawings of the present disclosure.

The capacitor body 110 may include the dielectric layer 111 and internal electrodes 121 and 122. The capacitor body 110 may include a plurality of dielectric layers 111. The internal electrodes 121 and 122 may include a first internal electrode 121 and a second internal electrode 122 disposed alternately and repeatedly in the stacking direction (T-axis direction).

The capacitor body 110 may include the first internal electrode 121 and the second internal electrode 122 alternately disposed in the stacking direction (T-axis direction) interposing the plurality of dielectric layers 111, and the dielectric layer 111.

Boundaries between adjacent dielectric layers 111 may be integrated to the degree that it may be difficult to confirm without using scanning electron microscopy (SEM).

The capacitor body 110 may include an active region. The active region may be a portion that contributes to forming the capacitance of the multilayer ceramic capacitor 100. For example, the active region may be a region where the first internal electrode 121 or the second internal electrode 122 stacked along the stacking direction (T-axis direction) overlap with each other.

The capacitor body 110 may further include a cover region and a side margin region.

The cover region is a marginal portion in the stacking direction, and may be located to be adjacent to the first surface and the second surface of the active region in the stacking direction (T-axis direction), respectively. For example, a single the dielectric layer 111 or two or more the dielectric layers 111 may be stacked on an upper surface and a lower surface of the active region, respectively, to be provided as the cover region.

The side margin region is a marginal portion in the width direction, and may be located to be adjacent to the fifth surface and the sixth surface of the active region in the width direction (W-axis direction), respectively. The side margin region may be formed by stacking the dielectric green sheets in which a conductive paste layer is applied to only a partial region of a dielectric green sheet surface, and the conductive paste layer is not applied to both side surfaces of the dielectric green sheet surface, and then firing it.

For example, through the cover region and the side margin region, the damage of the first internal electrode 121 and the second internal electrode 122 due to physical or chemical stress may be prevented.

The dielectric layer 111 may include a barium titanate-based compound as a primary component. For example, by using the barium titanate-based compound as a dielectric base material, dielectric characteristics of the multilayer ceramic capacitor 100 may be secured.

The barium titanate-based compound may include at least one selected from the group consisting of BaTiO₃, BaZrO₃, BaSnO₃, CaTiO₃, CaZrO₃, CaSnO₃, SrTiO₃, SrZrO₃, SrSnO₃, or the like. These may be used alone or in combination of two or more.

The dielectric layer 111 may further include a secondary component.

The secondary component may include at least one selected from the group consisting of manganese (Mn), chromium (Cr), silicon (Si), aluminum (Al), magnesium (Mg), tin (Sn), antimony (Sb), germanium (Ge), gallium (Ga), indium (In), barium (Ba), lanthanum (La), yttrium (Y), actinium (Ac), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), vanadium (V), or the like. These may be used alone or in combination of two or more.

According to an example, average thickness (T-axis direction average length) of the dielectric layer 111 may be about 1.0 μm to 8.0 μm. According to another example, average thickness (T-axis direction average length) of the dielectric layer 111 may be 2 μm to 6 μm. In the above ranges, reliability of the multilayer ceramic capacitor 100 may be further improved.

For example, the average thickness of the dielectric layer 111 may be based on a central point of the dielectric layer 111 in the length direction (L-axis direction) or the width direction (W-axis direction), in a scanning electron microscopy (SEM) analysis image of a cross-section (L-T cross-section) taken along the length direction (L-axis direction) and the stacking direction (T-axis direction) to be perpendicular to the width direction at a center of the multilayer ceramic capacitor 100 in the width direction (W-axis direction), and may be obtained as an arithmetic average value of thicknesses of the dielectric layer 111 measured at 10 points away from the reference point by a predetermined interval. The interval of the 10 points may be adjusted depending on the scale of the SEM image, and for example, may be an interval of 1 μm to 100 μm, 1 μm to 50 μm, or 1 μm to 10 μm. At this time, all the 10 points must be located within the dielectric layer 111, and when all the 10 points are not located within the dielectric layer 111, the location of the reference point may be changed, or the interval between the 10 points may be adjusted.

The first internal electrode 121 and the second internal electrode 122 may have different polarities. For example, the first internal electrode 121 and the second internal electrode 122 may be alternately disposed to face each other along the T-axis direction interposing the dielectric layer 111. For example, a first end of the first internal electrode 121 may be exposed through the third surface of the capacitor body 110, and a first end of the second internal electrode 122 may be exposed through the fourth surface of the capacitor body 110.

The first internal electrode 121 and the second internal electrode 122 may be electrically insulated by the dielectric layer 111 disposed therebetween.

An end portion of the first internal electrode 121 exposed through the third surface of the capacitor body 110 may be electrically connected to the first external electrode 131. For example, an end portion of the second internal electrode 122 exposed through the fourth surface of the capacitor body 110 may be electrically connected to the second external electrode 132.

The first internal electrode 121 and the second internal electrode 122 may include a conductive metal, respectively. For example, the conductive metal may include a metal such as Ni, Cu, Ag, Pd, or Au, or an alloy thereof (e.g., Ag—Pd alloy).

The first internal electrode 121 and the second internal electrode 122 may include dielectric particles of the same composition as the ceramic material included in the dielectric layer 111.

The first internal electrode 121 and the second internal electrode 122 may be formed by using a conductive paste including a conductive metal. For example, the conductive paste may be printed through a screen printing or gravure printing method.

According to an example, an average thickness of the first internal electrode 121 and the second internal electrode 122 may be 0.1 μm to 2 μm. In the above range, the resistance may be further reduced as the multilayer ceramic capacitor 100 becomes further miniaturized and thinner.

The average thickness of the first internal electrode 121 and the second internal electrode 122 may be measured by the SEM analysis. The SEM analysis may be substantially the same as the above-described method for measuring the average thickness of the dielectric layer 111.

The capacitor body 110 may be formed by firing a laminate in which the plurality of dielectric layers 111 and the internal electrodes 121 and 122 are stacked.

Referring to FIG. 2, the first external electrode 131 and the second external electrode 132 may have different polarities.

The first external electrode 131 may be in contact with and electrically connected to a portion where the first internal electrode 121 is exposed. For example, the second external electrode 132 may be in contact with and electrically connected to a portion where the second internal electrode 122 is exposed.

When a predetermined voltage is applied to the first external electrode 131 and the second external electrode 132, charges may be may accumulated between the first internal electrode 121 and the second internal electrode 122 facing each other. The capacitance of the multilayer ceramic capacitor 100 may be proportional to an overlapping area in a plan view of the first internal electrode 121 and the second internal electrode 122 that overlap with each other in the stacking direction (T-axis direction) in the active region.

The first external electrode 131 and the second external electrode 132 may include first and second connection portions (not shown) disposed on the third surface and the fourth surface of the capacitor body 110, respectively, and connected to the first internal electrode 121 and the second internal electrode 122, respectively. The first external electrode 131 and the second external electrode 132 may include first and second band portions (not shown) disposed on edges where the third surface and the fourth surface meet each other, the first surface and the second surface meet each other, or the fifth surface and the sixth surface of the capacitor body 110 meet each other.

The first and second band portions may extend from the first and second connection portions to a part of the first surface and the second surface or a part of the fifth surface and the sixth surface of the capacitor body 110, respectively. The fixing strength of the first external electrode 131 and the second external electrode 132 may be improved through the first and second band portions.

The external electrodes 131 and 132 may include electrode layers 10 and 20 located on the surface of the capacitor body 110.

The first external electrode 131 may include a first electrode layer 10 located directly on the surface (e.g., the third surface) of the capacitor body 110 and electrically connected to the first internal electrode 121. For example, the second external electrode 132 may include a second electrode layer 20 located directly on the surface (e.g., the fourth surface) of the capacitor body 110 and electrically connected to the second internal electrode 122.

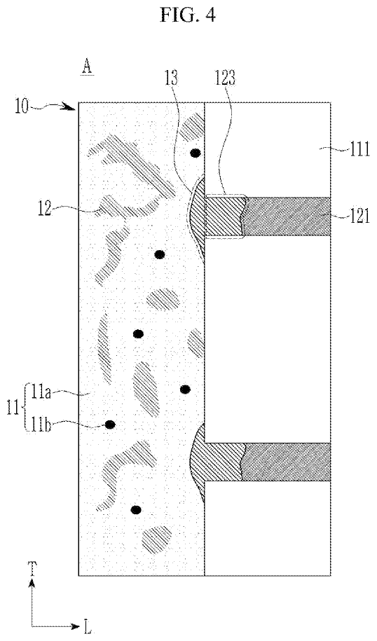

FIG. 4 is an enlarged partial cross-sectional view of the portion A of FIG. 2.

Referring to FIG. 4, the external electrodes 131 and 132 or the electrode layers 10 and 20 may include a conductive metal 11 and a glass 12. In an example, glasses 12 may be located dispersedly within the conductive metal 11. The conductive metal 11 and the glass 12 may be included in the electrode layers 10 and 20.

The conductive metal 11 may include nickel (Ni) 11a, and may include an auxiliary element 11b that includes at least one selected from the group consisting of tin (Sn), aluminum (Al), zirconium (Zr), indium (In) and cobalt (Co). Ni may be provided as a primary component of the conductive metal 11 and/or the electrode layers 10 and 20. Accordingly, the crack of the multilayer ceramic capacitor 100 in the radial direction may be suppressed, and the structural stability and reliability may be improved.

In an example, a plurality of auxiliary elements 11b may be located dispersedly within a primary component 11a of Ni.

Ni included in the external electrodes 131 and 132 may have a form of a Ni metal. For example, Ni included in the external electrodes 131 and 132 may not include a secondary structure such as Ni oxide.

The electrode layers 10 and 20 may not include copper (Cu). By using Ni instead of Cu as the primary component of the electrode layers 10 and 20, the damage of the multilayer ceramic capacitor 100 may be accordingly suppressed, the structural stability and reliability may be improved.

The glass 12 may include a composition in which oxides are mixed, and for example, may include at least one selected from the group consisting of silicon oxide, boron oxide, aluminum oxide, transition metal oxide, alkali metal oxide and alkaline-earth metal oxide.

The transition metal may include at least one selected from the group consisting of zinc (Zn), titanium (Ti), copper (Cu), vanadium (V), manganese (Mn), iron (Fe) and nickel (Ni). The alkali metal may include at least one selected from the group consisting of lithium (Li), sodium (Na) and potassium (K). The alkaline-earth metal may include at least one selected from the group consisting of magnesium (Mg), calcium (Ca), strontium (Sr) and barium (Ba).

The content of the glass may be 1 part by weight to 40 parts by weight based on totally 100 parts by weight of the conductive metal 11 (i.e., Ni and the auxiliary element 11b) included in the external electrodes 131 and 132. In the above range, density and stability of the external electrodes 131 and 132 may be further improved.

The above-described internal electrodes 121 and 122 may include a first interface region 123 in contact with the external electrodes 131 and 132.

The first interface region 123 may include an alloy of Ni and the auxiliary element 11b. Accordingly, the electrical connectivity between the external electrodes 131 and 132 and the internal electrodes 121 and 122 may be improved, and the capacitance characteristics and reliability of the multilayer ceramic capacitor 100 may be improved. The alloy may include Ni and the auxiliary element 11b together, or may represent an alloy in which Ni and the auxiliary element 11b are combined. For example, the alloy may include a Ni—Sn alloy.

According to an example, Ni of the alloy may come from the internal electrodes 121 and 122 and/or the external electrodes 131 and 132.

The internal electrodes 121 and 122 and the external electrodes 131 and 132 may be electrically connected through the alloy. For example, Ni of the internal electrodes 121 and 122 and Ni of the external electrodes 131 and 132 may be electrically connected through the alloy. By the auxiliary element 11b, an eutectic point of Ni and the auxiliary element 11b may be formed at a boundary between the external electrodes 131 and 132 and the internal electrodes 121 and 122 during sintering, and accordingly, an alloy of Ni and the auxiliary element 11b may be formed. Through the alloy, the connectivity of the external electrodes 131 and 132 and the internal electrodes 121 and 122 may be strengthened, and the capacitance characteristics and moisture resistance reliability may be improved.

The first interface region 123 may be a region where a content of the auxiliary element 11b measured through scanning electron microscopy-energy dispersive X-ray spectroscopy (SEM-EDS) or transmission electron microscopy-EDS (TEM-EDS) along a direction from an interface between the internal electrodes 121 and 122 and the external electrodes 131 and 132 toward an interior of the internal electrodes 121 and 122 is 5 mol % or more of a total amount of Ni and the auxiliary element 11b. Alternatively, the first interface region 123 may be a region of about 1 μm from the interface between the internal electrodes 121 and 122 and the external electrodes 131 and 132 in an inward direction of the internal electrodes 121 and 122.

The electrode layers 10 and 20 may include a second interface region 13 in contact with the internal electrodes 121 and 122, and the second interface region 13 may include an alloy of the above-described Ni and the auxiliary element 11b. Accordingly, the connectivity of the external electrodes 131 and 132 and the internal electrodes 121 and 122 may be further strengthened, and the capacitance characteristics of the multilayer ceramic capacitor 100 may be further improved.

The second interface region 13 may be a region where the content of the auxiliary element 11b measured through SEM-EDS along a direction from an interface between the electrode layers 10 and 20 and the internal electrodes 121 and 122 toward an interior of the electrode layers 10 and 20 is 5 mol % to 20 mol % of a total amount of Ni and the auxiliary element 11b. Alternatively, the second interface region 13 may be a region of about 1 μm from the interface between the electrode layers 10 and 20 and the internal electrodes 121 and 122 in an inward direction of the electrode layers 10 and 20.

The first interface region 123 and the second interface region 13 may be divided by a boundary of an imaginary line extending along an interface between the dielectric layer 111 and the electrode layers 10 and 20 or an interface between the capacitor body 110 and the external electrodes 131 and 132. For example, the imaginary line may extend in the stacking direction (T-axis direction) along the interface between the dielectric layer 111 and the electrode layers 10 and 20. Based on the imaginary line, the first interface region 123 may be located on a first side of the length direction (L-axis direction), and the second interface region 13 may be located on a second side of the length direction (L-axis direction).

The first interface region 123 and the second interface region 13 may be connected. For example, the first interface region 123 and the second interface region 13 may be provided as a substantially integrated single region. For example, Ni and the auxiliary element 11b may form the alloy at the eutectic point by sintering, and the first interface region 123 and the second interface region 13 may be defined according to the position where the alloy exists.

The presence/content of each of Ni, the auxiliary element 11b, and the alloy included in the first interface region 123 and the second interface region 13 may be confirmed and measured by performing the SEM analysis and EDS mapping with respect to a cross-section (L-T cross-section) taken along the length direction (L-axis direction) and the stacking direction (T-axis direction) to be perpendicular to the width direction at the center of the multilayer ceramic capacitor 100 in the width direction (W-axis direction). The multilayer ceramic capacitor 100 may be fixed by an epoxy resin, and may be polish by a polishing machine so that the L-T cross-section may be exposed. The polishing may be performed so that ½ of the length in the width direction (W-axis direction) is deleted. With respect to the exposed L-T cross-section, one to 6 rectangular regions of horizontally 40 μm and vertically 40 μm may be set so that the internal electrodes 121 and 122 and the electrode layers 10 and 20 may be included, and the SEM analysis images may be obtained with respect to the rectangular regions, respectively. By performing the EDS mapping and a line scan/point scan with respect to the SEM analysis images, a region where Ni and the auxiliary element 11b exist and the content of Ni and the auxiliary element 11b may be measured. A region where Ni and the auxiliary element 11b exist to overlap with each other at least partially may be evaluate as a region where the alloy exists. Information (position, content, or the like) on Ni, the auxiliary element 11b, and the alloy may be obtained by averaging the SEM-EDS analysis results with respect to the entire rectangular regions. Through the SEM-EDS analysis, the content of the glass 12 relative to the total amount of the above-described conductive metal 11 may be measured together.

The content of Ni 11a in the external electrodes 131 and 132 may be 80 mol % to 95 mol % with respect to the total amount of Ni 11a and the auxiliary element 11b in the external electrodes 131 and 132. In the above range, as the capacitance characteristics of the multilayer ceramic capacitor 100 is further improved, the connection stability of the internal electrodes 121 and 122 and the external electrodes 131 and 132 may be further improved.

The content of the auxiliary element 11b among the total amount of Ni 11a and the auxiliary element 11b included in the external electrodes 131 and 132 may be 5 mol % to 20 mol %. In the above range, as the driving reliability of the multilayer ceramic capacitor 100 is further improved, the deterioration of capacitance characteristics may be suppressed.

In an example, the external electrodes 131 and 132 may include a plurality of Ni metals and a plurality of auxiliary elements 11b. An average particle diameter of the Ni metal included in the external electrodes 131 and 132 and an average particle diameter of the auxiliary element 11b may be 0.05 μm to 10 μm, respectively. In the above range, the density of the external electrodes 131 and 132 may be further improved, and the alloy of Ni and auxiliary element may be formed more smoothly. The average particle diameter may be calculated by measuring maximum major axes of at least 100 particles for each element in the SEM analysis image of the L-T cross-section and creating a size distribution accumulative curve. The average particle diameter represents the size at a point where it becomes 50% on the size distribution accumulative curve. The average particle diameter may refer to D50.

According to an example, the external electrodes 131 and 132 may further include plating layers 30 and 40 located on the electrode layers 10 and 20.

The external electrodes 131 and 132 may further include, optionally, a conductive resin layer (not shown) located between the electrode layers 10 and 20 and the plating layers 30 and 40.

The conductive resin layer may extend to the first surface and the second surface, or the fifth surface and the sixth surface of the capacitor body 110. In this case, a length of a region (e.g., band portion) where the conductive resin layer is disposed may be longer than a length of a region (e.g., band portion) where the electrode layers 10 and 20 are disposed to extend to the first surface and the second surface, or the fifth surface and the sixth surface of the capacitor body 110. For example, the conductive resin layer may entirely cover the electrode layers 10 and 20.

The conductive resin layer may include a resin and a conductive member.

The resin is not particularly limited, if it has bondability and shock absorbing properties and is capable of being mixed with the conductive member powder to create a paste, and may include, for example, a phenol resin, an acryl resin, a silicone resin, an epoxy resin, or a polyimide resin.

The conductive member may be electrically connected to the internal electrodes 121 and 122 or the electrode layers 10 and 20.

The conductive member may have a spherical shape, a flake shape, or a combination thereof. For example, the conductive member may be formed only in the flake shape or only in the spherical shape, and may include a mixed shape of the flake shape and the spherical shape.

The spherical shape may include a shape that is not perfectly spherical shape, and for example, may include a shape in which a length ratio of a major axis and a minor axis (i.e., major axis/minor axis) is less than or equal to 1.45. The flake-shaped powder refers to a powder having a flat and elongated shape, and for example, a length ratio of a major axis and a minor axis (i.e., major axis/minor axis) may be greater than or equal to 1.95, although not limited thereto.

The external electrodes 131 and 132 may further include the plating layers 30 and 40 disposed to cover the above-described conductive resin layer.

The plating layers 30 and 40 may include a first plating layer 30 disposed on the first electrode layer 10 and a second plating layer 40 disposed on the second electrode layer 20.

The plating layers 30 and 40 may include nickel (Ni), copper (Cu), tin (Sn), palladium (Pd), platinum (Pt), gold (Au), silver (Ag), tungsten (W), titanium (Ti), lead (Pb), an alloy thereof, or the like. These may be used alone or in combination of two or more.

The plating layers 30 and 40 may be a nickel (Ni) plating layer or a tin (Sn) plating layer. For example, the plating layers 30 and 40 may include a nickel (Ni) plating layer and a tin (Sn) plating layer are sequentially stacked or the form in which a tin (Sn) plating layer, a nickel (Ni) plating layer, and a tin (Sn) plating layer are sequentially stacked. For example, the plating layers 30 and 40 may include a plurality of nickel (Ni) plating layers and/or a plurality of tin (Sn) plating layers.

Through the plating layers 30 and 40, mountability on a substrate, structural reliability, durability against external impact, heat resistance, and equivalent series resistance (ESR) of the multilayer ceramic capacitor 100 may be improved.

Hereinafter, a method for preparing the multilayer ceramic capacitor 100 according to still another example will be described.

A method for preparing the multilayer ceramic capacitor 100 may include manufacturing the capacitor body 110 including the dielectric layer 111 and the internal electrodes 121 and 122, and forming the external electrodes 131 and 132 on the outer side of the capacitor body 110.

In the manufacturing process of the capacitor body 110, a dielectric paste that becomes the dielectric layer 111 after firing and a conductive paste that becomes the internal electrodes 121 and 122 after firing may be prepared.

A calcined powder may be obtained by uniformly mixing and drying the dielectric powder through wet mixing or the like, and then by heat-treating under a predetermined condition. The dielectric paste may be manufactured by adding an organic vehicle or aqueous vehicle into the calcined powder and heating and mixing them.

The dielectric paste may be formed into a sheet by a technique such as a doctor blade method, to obtain the dielectric green sheet. For example, the dielectric paste may include an additive selected from various dispersants, a plasticizer, a dielectric material, a secondary component compound, glass, and/or the like.

The conductive paste for an internal electrode may be prepared by mixing a conductive powder made of a conductive metal or an alloy thereof with a binder or solvent.

The conductive paste for an internal electrode may include indium (In).

The conductive paste for an internal electrode may include ceramic powder (e.g., barium titanate powder) as a co-material. The co-material may inhibit sintering of the conductive powder during the firing process.

The conductive paste for an internal electrode may be applied to the dielectric green sheet surface in a predetermined pattern by using various printing methods such as screen printing or a transfer method. A dielectric green sheet laminate may be obtained by stacking dielectric green sheets having internal electrode patterns in a plurality of layers and by pressurizing it in the stacking direction. The dielectric green sheet and the internal electrode pattern may be stacked so that the dielectric green sheet may be located on an upper surface and a lower surface of the dielectric green sheet laminate in the stacking direction.

Optionally, the dielectric green sheet laminate may be cut to a predetermined size by dicing or the like.

The dielectric green sheet laminate may be solidified and dried to remove plasticizers or the like, if necessary, and after solidifying and drying, may be barrel polished by using horizontal centrifugal barrel machine, or the like. In the barrel polishing, the dielectric green sheet laminate is placed into a barrel container together with media and polishing liquid, and rotational motion, vibration, or the like is applied to the barrel container, to polish unnecessary portions such as burr generated during cutting. For example, after the barrel polishing, the dielectric green sheet laminate may be washed with a cleaning solution such as water and dried.

The dielectric green sheet laminate may be subjected to binder removal treatment and firing treatment, to obtain the capacitor body 110.

The conditions for the binder removal treatment may be appropriately adjusted according to the composition of the primary component of the dielectric layer or the composition of the primary component of the internal electrode. For example, at the time of the binder removal treatment, the temperature increasing rate may be 5° C./hour to 300° C./hour, the support temperature may be 180° C. to 400° C., and the temperature maintaining time may be 0.5 hours to 24 hours. The binder removal atmosphere may be air or a reducing atmosphere.

The conditions for the firing treatment may be appropriately adjusted according to the composition of the primary component of the dielectric layer or the composition of the primary component of the internal electrode. For example, the temperature during firing may be 1200° C. to 1350° C., or 1220° C. to 1300° C., and the time may be 0.5 hours to 8 hours, or 1 hour to 3 hours. The firing atmosphere may be a reducing atmosphere, and for example, an atmosphere of a humidified mixture of nitrogen gas (N2) and hydrogen gas (H2). When the internal electrodes 121 and 122 include nickel (Ni) or a nickel (Ni) alloy, the oxygen partial pressure in firing atmosphere may be 1.0×10⁻¹⁴ MPa to 1.0×10⁻¹⁰ MPa.

After the firing treatment, annealing may be performed if necessary. The annealing is a treatment for re-oxidizing the dielectric layer, and the annealing may be performed in the case that the firing treatment was performed in a reducing atmosphere. The conditions for the annealing treatment may also be appropriately adjusted according to the composition of the primary component of the dielectric layer or the like. For example, the temperature at the time of annealing may be 950° C. to 1150° C., the time may be 0 hours to 20 hours, and temperature increasing rate may be 50° C./hour to 500° C./hour. The annealing atmosphere may be a humidified nitrogen gas (N2) atmosphere, and oxygen partial pressure may be 1.0×10−9 MPa to 1.0×10⁻⁵ MPa.

In the binder removal treatment, the firing treatment, or the annealing treatment, in order to humidify nitrogen gas, mixed gas, or the like, for example, a wetter or the like may be used, and in this case, the water temperature may be 5° C. to 75° C. The binder removal treatment, the firing treatment, and the annealing treatment may be consecutively performed, and may be independently performed.

Optionally, the third surface and the fourth surface of the obtained capacitor body 110 may be subjected to surface treatment such as sandblasting treatment, laser irradiation, or barrel polishing. Through such surface treatment, end portions of the first internal electrode 121 and the second internal electrode 122 may be exposed on the surface of the third surface and the fourth surface. Accordingly, the electrical junction between the first external electrode 131 and the second external electrode 132 and the first internal electrode 121 and the second internal electrode 122 may be improved, and the alloy portion may be easily formed.

By forming the electrode layers 10 and 20 by applying a paste for forming an electrode layer on an outer surface of the capacitor body 110 and sintering it, the external electrodes 131 and 132 may be manufactured.

The paste for forming an electrode layer may include the conductive metal 11 and the glass composition. The glass 12 may be formed as the glass composition is fired.

The conductive metal 11 may include Ni and an auxiliary element including at least one of Sn, Al, Zn, In, and Co. An alloy of the auxiliary element and Ni may be formed according to sintering, and accordingly, the connection of the internal electrodes 121 and 122 and the external electrodes 131 and 132 may be improved.

The glass composition may include at least one selected from a group consisting of Si oxide, Al oxide, Fe oxide, Sn oxide, Zn oxide, Li oxide, Na oxide, K oxide, Ba oxide, Ca oxide, Sr oxide, B oxide, Ni oxide, Mn oxide, Ge oxide, Cu oxide, In oxide, Co oxide, Ti oxide, and P oxide.

For example, the glass composition may include at least one selected from the group consisting of Li₂O, Na₂O, K₂O, SiO₂, Al₂O₃, FeO, Fe₂O₃, Fe₃O₄, NiO, Ni₂O₃, Ni₃O₄, In₂O₃, TiO₂, P₂O₅, BaO, CaO, SrO, B₂O₃, ZnO, SnO, SnO₂, Cu₂O, CuO, CoO, Co₂O₃, GeO₂, MnO, Mn₂O, Mn₂O₃, Mn₃O₄, and the like. These may be used alone or in combination of two or more.

The glass 12 may be prepared by mixing the components of the glass composition, heat-treating them at predetermined temperature or higher, quenching them, and then atomizing them, or by using a gaseous, liquid, or spray pyrolysis method, or the like.

The paste for forming an electrode layer may further include a binder, a solvent, a dispersant, a plasticizer, oxide powder, or the like.

The binder may include, for example, ethylcellulose, acryl, butyral, or the like, and the solvent may include, for example, an organic solvent or an aqueous solvent, such as terpineol, butylcarbitol, alcohol, methyl ethyl ketone, acetone, and toluene.

The content of Ni among the total amount of Ni and the auxiliary element included in the paste for forming an electrode layer may be 80 mol % to 95 mol %. In the above range, as the capacitance characteristics of the multilayer ceramic capacitor 100 is further improved, the connection stability of the internal electrodes 121 and 122 and the external electrodes 131 and 132 may be further improved.

The content of the auxiliary element among the total amount of Ni and the auxiliary element included in the paste for forming an electrode layer may be 5 mol % to 20 mol %. In the above range, as the driving reliability of the multilayer ceramic capacitor 100 is further improved, the deterioration of capacitance characteristics may be suppressed.

As a method of applying the paste for forming an electrode layer to the outer surface of the capacitor body 110, a dip method, various printing methods such as screen printing, a coating method using dispenser or the like, a spraying method using a spray or the like, or the like may be used. The paste for forming an electrode layer may be applied to at least the third surface and the fourth surface of the capacitor body 110, and optionally, may also be applied to a part of the first surface, the second surface, the fifth surface, or the sixth surface where band portions of the first external electrode and the second external electrode are formed.

The sintering may be performed at a temperature of 500° C. to 850° C. In the above range, the alloy of Ni and the auxiliary element may be sufficiently formed, and the connection stability between the internal electrodes 121 and 122 and the external electrodes 131 and 132 may be further improved.

Subsequently, optionally, a paste for forming a conductive resin layer is applied to the outer surface of the capacitor body 110 where the electrode layers 10 and 20 are formed and then cured, to form the conductive resin layer.

The paste for forming a conductive resin layer may include a resin and, optionally, a conductive metal or a non-conductive filler. The description of the conductive metal and resin is the same as described above, and the repeated description will not be included here again. In addition, the paste for forming a conductive resin layer may include, optionally, a binder, a solvent, a dispersant, a plasticizer, oxide powder, or the like. The binder may include, for example, ethylcellulose, acryl, butyral, or the like, and the solvent may include an organic solvent or an aqueous solvent, such as terpineol, butylcarbitol, alcohol, methyl ethyl ketone, acetone, and toluene.

As an example, the conductive resin layer may be formed by dipping the capacitor body 110 into the paste for forming a conductive resin layer and then curing it, or by printing the paste for forming a conductive resin layer on the surface of the capacitor body 110 by a screen printing or gravure printing method or the like, or by applying the paste for forming a conductive resin layer to the surface of the capacitor body 110 and then curing it.

The plating layers 30 and 40 may be formed on outer side of the conductive resin layer.

The plating layers 30 and 40 may be formed by a plating method, and may be formed by sputtering or electric deposition.

The internal electrodes 121 and 122 of the multilayer ceramic capacitor 100 formed according to the above-described manufacturing method may include the first interface region 123 in contact with the external electrodes 131 and 132, and the first interface region 123 may include an alloy of Ni and the auxiliary element.

The electrode layers 10 and 20 may include the second interface region 13 in contact with the internal electrodes 121 and 122, and the second interface region 13 may include an alloy of Ni and the auxiliary element.

Hereinafter, specific examples of the present disclosure will be presented. However, the examples described below are merely for exemplification or description.

### Examples 1 to 10

### (Preparation of Multilayer Ceramic Capacitor)

After preparing the dielectric green sheet by using barium titanate (BaTiO₃) as the primary component powder, the conductive paste layer including Ni is printed on the dielectric green sheet surface, and the dielectric green sheet (Width×Depth×Height=3.2 mm×2.5 mm×2.5 mm) where the conductive paste layer is formed is stacked and squeezed, to prepare the dielectric green sheet laminate. The dielectric green sheet laminate was subjected to a plasticizing process at 400° C. or lower in a nitrogen atmosphere, and then fired under the conditions of a firing temperature of 1300° C. or less and a hydrogen concentration 1.0% H₂ or less, to prepare a capacitor body.

The paste for forming an electrode layer was prepared by mixing and dispersing 65 wt % of Ni, 5 wt % of Sn, 10 wt % of glass composition, 15 wt % of binder and 5 wt % of dispersant (total 100 wt %). The glass composition included 9.0 mol % of lithium oxide (Li₂O), 10 mol % of oxidation sodium (Na₂O), 1.5 mol % of iron oxide (III) (Fe₂O₃), zinc oxide (ZnO) 6.3 mol %, 21 mol % of barium oxide (BaO), silicon dioxide (SiO₂) 11 mol %, 8 mol % of calcium oxide (CaO), aluminum oxide (Al₂O₃) 12 mol %, 20.2 mol % of boron trioxide (B₂O₃), and 1 mol % of tin oxide (IV) (SnO₂) (total 100 mol %).

The paste for forming an electrode layer was applied to the outer surface of the capacitor body and dried, and then, as shown in the following Table 1, sintered at 400° C. to 850° C., to form an electrode layer of the external electrode. The sintering may be performed in a N₂ gas atmosphere or a mixed gas atmosphere of N₂ and H₂, and was performed under a N₂ gas atmosphere. Subsequently, a Ni plating layer and a Sn plating layer were sequentially formed on the surface of the electrode layer, to prepare the multilayer ceramic capacitor.

### Comparative Examples 1 to 10

The multilayer ceramic capacitors of Comparative Examples 1 to 10 were prepared in the same method as Examples 1 to 10, respectively, except that Sn was not added to the paste for forming an electrode layer.

### Evaluation 1: the SEM Analysis

The multilayer ceramic capacitors according to Example 7 and Comparative Example 7 were laid down horizontally, and the area around the multilayer ceramic capacitor was fixed with epoxy resin.

Polishing was performed by a polishing machine so that a cross-section (L-T cross-section) taken along the length direction (L-axis direction) and the stacking direction (W-axis direction) to be perpendicular to the width direction at a center of the multilayer ceramic capacitor in the width direction (W-axis direction) may be exposed.

With respect to the exposed L-T cross-section, a rectangular region of horizontally 40 μm and vertically 40 μm was set at the center in the stacking direction (T-axis direction) to include the internal electrode layer and the electrode layer, and SEM photographing was performed with respect to the rectangular region. The SEM photographing were performed by using a Verios G4 from Thermofisher Scientific under an accelerating voltage of 200 kV.

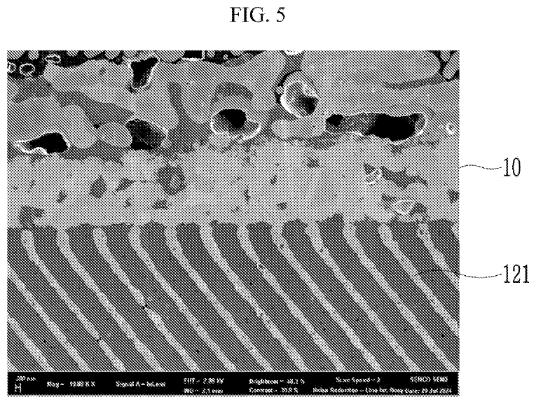

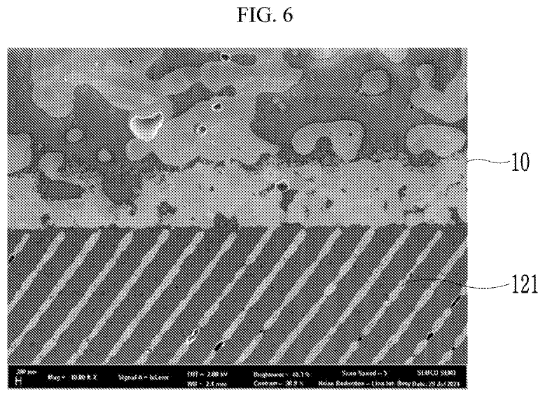

FIG. 5 is the SEM analysis image of the multilayer ceramic capacitor according to Example 7. FIG. 6 is the SEM analysis image of the multilayer ceramic capacitor according to Comparative Example 7.

Referring to FIG. 5 and FIG. 6, in Example 7, discontinuous portions of the internal electrode and the external electrode decreased and the connectivity was improved, compared to Comparative Example 7 having the same sintering temperature.

### Evaluation 2: Capacitance Evaluation

With respect to the multilayer ceramic capacitors of the above-described Examples and Comparative Examples, the capacitance thereof was measured by applying a rated voltage.

In more detail, the capacitance was measured by using Agilent 4268A of HP/Agilent under the condition of 1 kHz and 1 V.

The measurement results were evaluated as follows.
⊚: 90% to 100% of the measured maximum capacitance
∘: 60% or more and less than 90% of the measured maximum capacitance
Δ: 30% or more and less than 60% of the measured maximum capacitance
X: less than 30% of the measured maximum capacitance

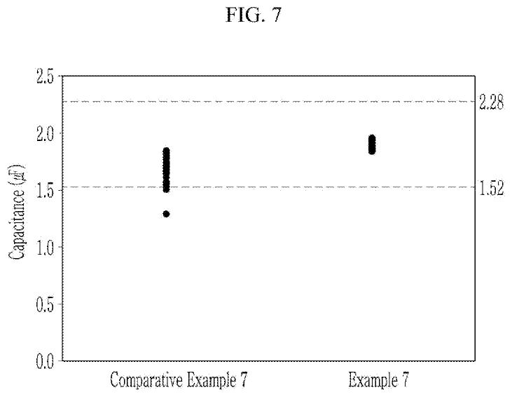

FIG. 7 is a graph showing the capacitance of the multilayer ceramic capacitor according to each of Example 7 and Comparative Example 7.

Referring to FIG. 7, in Example 7, the capacitance characteristics was relatively improved, compared to Comparative Example 7 having the same sintering temperature.

### Evaluation 3: Equivalent Series Resistance (ESR) Evaluation

Samples were prepared, where 40 multilayer ceramic capacitors prepared according to the above-described Examples and Comparative Examples were welded to an aluminum belt to prepare each sample. The ESR was measure with respect to the sample by using the E4980A model of KEYSIGHT under the condition of 100 kHz and 1.5±0.5V.
⊚: 100% to 110% of the measured minimum ESR
∘: more than 110% and 130% or less of the measured minimum ESR
Δ: more than 130% and 160% or less of the measured minimum ESR
X: more than 160% of the measured minimum ESR

### Evaluation 4: Moisture Resistance Reliability Evaluation

With respect to the multilayer ceramic capacitors prepared according to the above-described Examples and Comparative Examples, the moisture resistance reliability was evaluated by measuring the change of insulation resistance (IR) for 20 hours by using the ESPEC PR-3J equipment under the condition of 95° C., relative humidity 95%, and 12 V.

In more detail, the measurement results was evaluated as follows.
⊚: IR is greater than 1.0×10⁷Ω
∘: IR is greater than 1.0×10⁶Ω and less than or equal to 1.0×10⁷Ω
Δ: IR is greater than 1.0×10⁵Ω and less than or equal to 1.0×10⁶Ω
X: IR is less than 1.0×10⁵Ω

The sintering temperature and evaluation results of the conductive paste for an electrode are represented in the following Table 1.

TABLE 1

| | | | | Moisture |
|---|---|---|---|---|
| | Sintering | | | resistance |
| | temperature (° C.) | Capacitance | ESR | reliability |
| Example 1 | 400 | ◯ | Δ | ◯ |
| Example 2 | 450 | ◯ | Δ | ◯ |
| Example 3 | 500 | ◯ | ◯ | ◯ |
| Example 4 | 550 | ◯ | ◯ | ◯ |
| Example 5 | 600 | ⊚ | ⊚ | ⊚ |
| Example 6 | 650 | ⊚ | ⊚ | ⊚ |
| Example 7 | 700 | ⊚ | ⊚ | ⊚ |
| Example 8 | 750 | ⊚ | ⊚ | ⊚ |
| Example 9 | 800 | ⊚ | ⊚ | ⊚ |
| Example 10 | 850 | ◯ | ◯ | ⊚ |
| Comparative | 400 | X | X | X |
| Example 1 | | | | |
| Comparative | 450 | X | X | X |
| Example 2 | | | | |
| Comparative | 500 | X | X | X |
| Example 3 | | | | |
| Comparative | 550 | X | X | X |
| Example 4 | | | | |
| Comparative | 600 | X | X | X |
| Example 5 | | | | |
| Comparative | 650 | X | Δ | X |
| Example 6 | | | | |
| Comparative | 700 | Δ | Δ | Δ |
| Example 7 | | | | |
| Comparative | 750 | Δ | Δ | ◯ |
| Example 8 | | | | |
| Comparative | 800 | Δ | Δ | ◯ |
| Example 9 | | | | |
| Comparative | 850 | X | X | ⊚ |
| Example 10 | | | | |

Referring to Table 1 above, in the Examples in which the alloy of Ni and the auxiliary element is located in the region where the internal electrode and the external electrode are in contact with each other, the capacitance characteristics and moisture resistance reliability were improved and the ESR decreased, compared to Comparative Examples sintered at the same temperature.

What is claimed is:

1. A multilayer ceramic capacitor, comprising:
a capacitor body comprising a dielectric layer and an internal electrode; and
an external electrode located on an outer side of the capacitor body, and comprising Ni and an auxiliary element including at least one selected from the group consisting of Sn, Al, Zn, In, and Co,
wherein the internal electrode comprises a first interface region in contact with the external electrode, and
wherein the first interface region comprises an alloy comprising Ni and the auxiliary element together.

2. The multilayer ceramic capacitor of claim 1, wherein the first interface region is a region in which a content of the auxiliary element measured through scanning electron microscopy-energy dispersive X-ray spectroscopy (SEM-EDS) along a direction from an interface between the internal electrode and the external electrode toward an interior of the internal electrode is 5 mol % or more of a total amount of Ni and the auxiliary element.

3. The multilayer ceramic capacitor of claim 1, wherein:
the external electrode comprises an electrode layer electrically connected to the internal electrode; and
the electrode layer comprises Ni and the auxiliary element.

4. The multilayer ceramic capacitor of claim 3, wherein:
the electrode layer comprises a second interface region in contact with the internal electrode; and
the second interface region comprises an alloy including Ni and the auxiliary element.

5. The multilayer ceramic capacitor of claim 4, wherein the second interface region is a region where a content of the auxiliary element measured through SEM-EDS along a direction from an interface between the electrode layer and the internal electrode toward an interior of the electrode layer is 5 mol % to 20 mol % of a total amount of Ni and the auxiliary element.

6. The multilayer ceramic capacitor of claim 4, wherein the first interface region and the second interface region are connected.

7. The multilayer ceramic capacitor of claim 3, wherein the electrode layer does not comprise Cu.

8. The multilayer ceramic capacitor of claim 1, wherein a content of Ni is 80 mol % to 95 mol % with respect to a total amount of Ni and the auxiliary element in the external electrode.

9. The multilayer ceramic capacitor of claim 1, wherein a content of the auxiliary element is 5 mol % to 20 mol % with respect to a total amount of Ni and the auxiliary element in the external electrode.

10. The multilayer ceramic capacitor of claim 1, wherein Ni in the external electrode has a form of a Ni metal.

11. The multilayer ceramic capacitor of claim 1, wherein the internal electrode comprises Ni, and the internal electrode and the external electrode are electrically connected through the alloy.

12. The multilayer ceramic capacitor of claim 1, wherein the external electrode further comprises glass.

13. The multilayer ceramic capacitor of claim 12, wherein a content of the glass is in a range from 1 part by weight to 40 parts by weight based on 100 parts by weight of Ni and the auxiliary element in the external electrode.

14. The multilayer ceramic capacitor of claim 1, wherein the external electrode comprises Ni particles formed by a plurality of Ni metals and auxiliary particles formed by a plurality of auxiliary elements, and an average diameter of the Ni particles and an average diameter of the auxiliary particles in the external electrode are 0.05 μm to 10 μm.

15. A method of preparing a multilayer ceramic capacitor, comprising:
applying a paste for forming an electrode layer to a first surface of a capacitor body comprising a dielectric layer and an internal electrode; and
sintering the paste for forming an electrode layer to form the electrode layer of an external electrode,
wherein the paste for forming an electrode layer comprises Ni and an auxiliary element which comprises at least one selected from the group consisting of Sn, Al, Zn, In, and Co,
wherein the internal electrode comprises a first interface region in contact with the external electrode, and
wherein the first interface region comprises an alloy of Ni and the auxiliary element.

16. The method of claim 15, wherein the sintering is performed at 500° C. to 850° C.

17. The method of claim 15, wherein:
the electrode layer comprises a second interface region in contact with the internal electrode, and
the second interface region comprises an alloy of Ni and the auxiliary element.

18. The method of claim 15, wherein a content of Ni among a total amount of Ni and the auxiliary element comprised in the paste for forming an electrode layer is 80 mol % to 95 mol %.

19. The method of claim 15, wherein a content of the auxiliary element is 5 mol % to 20 mol % with respect to a total amount of Ni and the auxiliary element in the paste for forming an electrode layer.
